(19) United States
(12) Patent Application Publication
(10) Pub. No.: US 2023/0180976 A1
(43) Pub. Date: Jun. 15, 2023

(54) TOILET SEAT LOCKING DEVICE

(71) Applicant: Damian Sgro, Brampton (CA)

(72) Inventor: Damian Sgro, Brampton (CA)

(21) Appl. No.: 17/551,771

(22) Filed: Dec. 15, 2021

(51) Int. Cl. A47K 13/24; E05B 65/00

(52) U.S. Cl. CPC A47K 13/242; E05B 65/0014

(57) ABSTRACT

The toilet seat locking device disclosed herein may comprise a toilet lid cover secured to a toilet by a keyed or padlocked locking mechanism so that it cannot be removed without the appropriate key, code, or combination. The toilet seat locking device may comprise any appropriate flexible, resilient material, and may attach securely to a toilet base by wrapping an adjustable strap around the base. The material of construction of the toilet seat locking device may comprise reusable, waterproof, and antimicrobial characteristics so as to provide additional functional advantages to the device.

### TECHNICAL FIELD OF THE INVENTION

The present invention relates in general to toilet accessories, and, more specifically, to a toilet seat locking device.

### COPYRIGHT AND TRADEMARK NOTICE

A portion of the disclosure of this patent application may contain material that is subject to copyright protection. The owner has no objection to the facsimile reproduction by anyone of the patent document or the patent disclosure, as it appears in the Patent and Trademark Office patent file or records, but otherwise reserves all copyrights whatsoever.

Certain marks referenced herein may be common law or registered trademarks of third parties affiliated or unaffiliated with the applicant or the assignee. Use of these marks is by way of example and should not be construed as descriptive or to limit the scope of this invention to material associated only with such marks.

### BACKGROUND OF THE INVENTION

A toilet is a sanitation device that collects human waste and routes it into a sewer system or septic tank. Toilets are usually placed in specialized rooms, such as a bathroom or outhouse, and are generally made from ceramics, concrete, plastics, or other solid materials. Modern toilets generally comprise a toilet seat mounted on a bowl, a lid covering the toilet seat, and a water tank containing the flushing mechanism. The bowl itself is usually incorporated into a toilet base, and the water tank is usually mounted to the toilet base, which itself is mounted to a floor.

The process of using a toilet is a necessarily unsanitary practice, especially considering that human wastes, which are considered biohazardous material, are involved. Such human wastes are prone to carrying a significant number of diseases, are attributed with noxious smells, and are potentially staining to surfaces in and around a toilet. These issues are compounded by the fact that many users of toilets may be inconsiderate of cleaning the toilet and the surrounding area after use, especially if the toilet does not belong to the user. Such issues are particularly prevalent in public-use toilets.

Such a problem becomes exceedingly relevant when a private toilet becomes openly accessible, such as when a person is hosting a social event in their home or is hosting an open house while trying to sell their home. A number of solutions exist to prevent others from using a private toilet, but all of these solutions are lacking in some way.

By way of example, it is known in the art to have a “toilet lock” that generally comprises an attachment mechanism and a locking arm. In one embodiment such a toilet lock may attach to a toilet lid by a suction mechanism and may jam the locking arm against the toilet tank, thus preventing the lid from being lifted. In another embodiment the toilet lock may be attached to the toilet tank by a suction mechanism and may jam the locking arm against the toilet lid. In either embodiment the locking arm may further comprise an articulating mechanism so that the arm may be unjammed, allowing the lid to be opened. Another variation of such a toilet lock generally comprises an attachment between the toilet lid and toilet bowl.

The problem with such a design is that these devices are meant to prevent children from accessing the toilet and can be easily removed by a person, such as an adult, that is able to disengage the locking arm. No solution exists that allows the toilet lid to be locked to a toilet in such a way that it cannot be removed except by the user that installed the device.

Thus, there is a need in the art for a toilet seat locking device that may comprise a toilet lid cover secured to a toilet by a keyed or padlocked locking mechanism so that it cannot be removed without the appropriate key, code, or combination. The toilet seat locking device may comprise any appropriate flexible, resilient material, and may attach securely to a toilet base by wrapping an adjustable strap around the base. The material of construction of the toilet seat locking device may comprise reusable, waterproof, and antimicrobial characteristics so as to provide additional functional advantages to the device. It is to these ends that the present invention has been developed.

### BRIEF SUMMARY OF THE INVENTION

To minimize the limitations in the prior art, and to minimize other limitations that will be apparent upon reading and understanding the present specification, the present invention describes a toilet seat locking device.

It is an objective of the present invention to provide a toilet seat locking device that may comprise a main body.

It is another objective of the present invention to provide a toilet seat locking device that may comprise a top panel.

It is another objective of the present invention to provide a toilet seat locking device that may comprise a side panel.

It is another objective of the present invention to provide a toilet seat locking device that may comprise a front panel.

It is another objective of the present invention to provide a toilet seat locking device that may comprise a locking strap.

It is another objective of the present invention to provide a toilet seat locking device that may comprise a receiving strap.

It is another objective of the present invention to provide a toilet seat locking device that may comprise a locking mechanism.

It is another objective of the present invention to provide a toilet seat locking device that may comprise a plurality of locking holes.

It is another objective of the present invention to provide a toilet seat locking device that may comprise a lock.

It is another objective of the present invention to provide a toilet seat locking device that may comprise a plurality of support straps.

It is another objective of the present invention to provide a toilet seat locking device that may comprise a resilient material of construction.

It is another objective of the present invention to provide a toilet seat locking device that may comprise a water-proof material of construction.

It is another objective of the present invention to provide a toilet seat locking device that may comprise a reusable material of construction.

It is another objective of the present invention to provide a toilet seat locking device that may comprise an antimicrobial layer.

It is another objective of the present invention to provide a toilet seat locking device that may comprise an antimicrobial material of construction.

These and other advantages and features of the present invention are described herein with specificity so as to make the present invention understandable to one of ordinary skill in the art, both with respect to how to practice the present invention and how to make the present invention.

### BRIEF DESCRIPTION OF THE SEVERAL VIEWS OF THE DRAWINGS

Elements in the figures have not necessarily been drawn to scale in order to enhance their clarity and improve understanding of these various elements and embodiments of the invention. Furthermore, elements that are known to be common and well understood to those in the industry are not depicted in order to provide a clear view of the various embodiments of the invention.

FIG. 1 is an isometric perspective view of a toilet seat locking device, as contemplated by the present disclosure;

FIG. 2 is a front plan view of a toilet seat locking device, as contemplated by the present disclosure;

FIG. 3 is a rear plan view of a toilet seat locking device, as contemplated by the present disclosure;

FIG. 4 is a left side elevation view of a toilet seat locking device, as contemplated by the present disclosure;

FIG. 5 is a right side elevation view of a toilet seat locking device, as contemplated by the present disclosure;

FIG. 6 is a top plan view of a toilet seat locking device, as contemplated by the present disclosure;

FIG. 7 is a bottom plan view of a toilet seat locking device, as contemplated by the present disclosure;

FIG. 8 is an isometric perspective view of a toilet seat locking device, as contemplated by the present disclosure;

FIG. 9 is an isometric perspective view of a toilet seat locking device with a locking mechanism installed, as contemplated by the present disclosure;

FIG. 10 is an overall view of a toilet seat locking device installed on an exemplary toilet, as contemplated by the present disclosure;

FIG. 11 is a front plan view of a toilet seat locking device installed on an exemplary toilet, as contemplated by the present disclosure;

FIG. 12 is an overall view of an alternate locking mechanism of a toilet seat locking device, as contemplated by the present disclosure;

FIG. 13 is a detailed view of an alternate locking mechanism of a toilet seat locking device, as contemplated by the present disclosure; and

FIG. 14 is an isometric perspective view of a second embodiment of a toilet seat locking device, as contemplated by the present disclosure.

### DETAILED DESCRIPTION OF THE INVENTION

Certain terminology is used in the following description for reference only and is not limiting. The words “front,” “rear,” “anterior,” “posterior,” “lateral,” “medial,” “upper,” “lower,” “outer,” “inner,” and “interior” refer to directions toward and away from, respectively, the geometric center of the invention, and designated parts thereof, in accordance with the present disclosure. Unless specifically set forth herein, the terms “a,” “an,” and “the” are not limited to one element, but instead should be read as meaning “at least one.” The terminology includes the words noted above, derivatives thereof, and words of similar import.

The toilet seat locking device disclosed herein may comprise a toilet lid cover secured to a toilet by a keyed or padlocked locking mechanism so that it cannot be removed without the appropriate key, code, or combination. The toilet seat locking device may comprise any appropriate flexible, resilient material, and may attach securely to a toilet base by wrapping an adjustable strap around the base. The material of construction of the toilet seat locking device may comprise reusable, waterproof, and antimicrobial characteristics so as to provide additional functional advantages to the device.

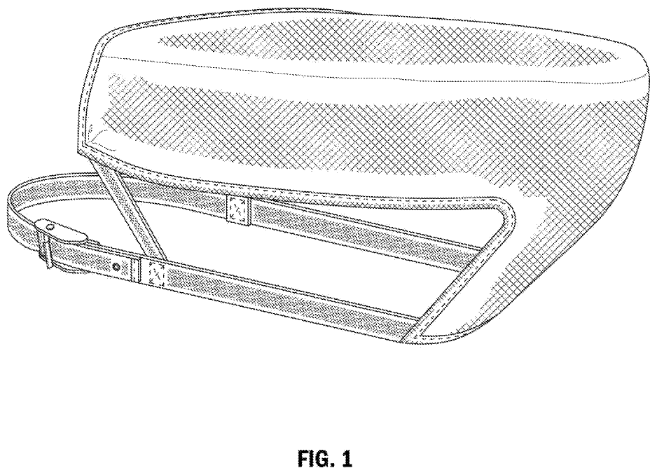

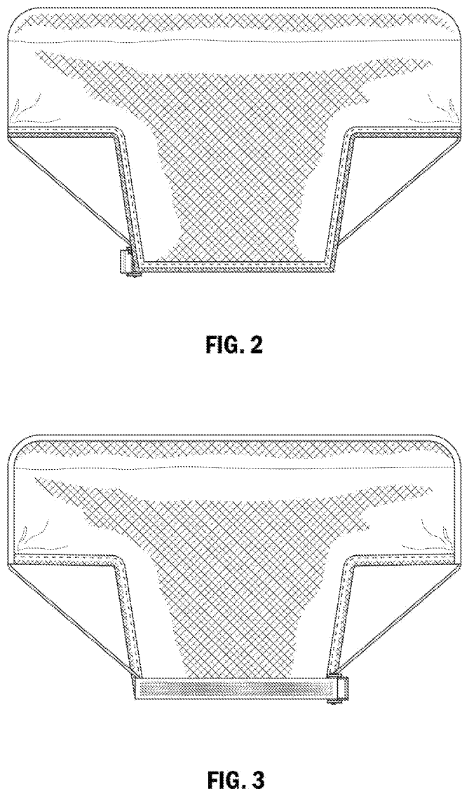

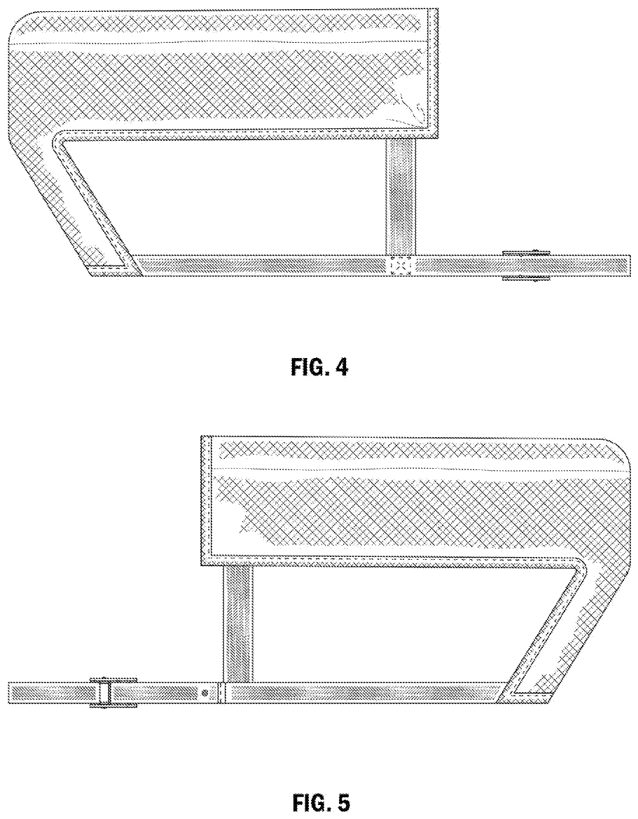

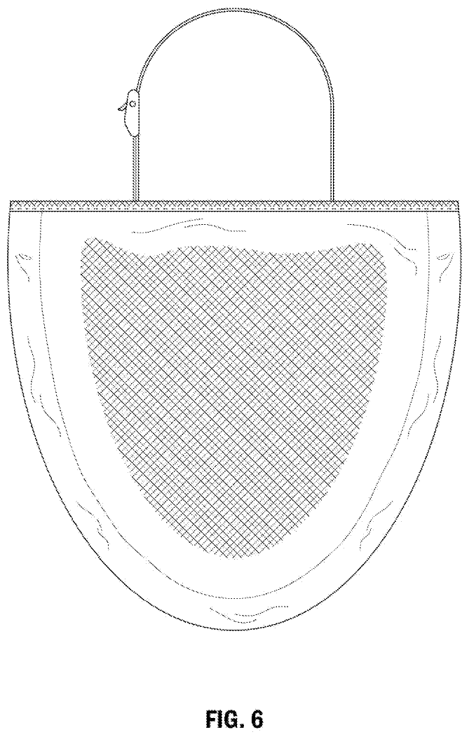

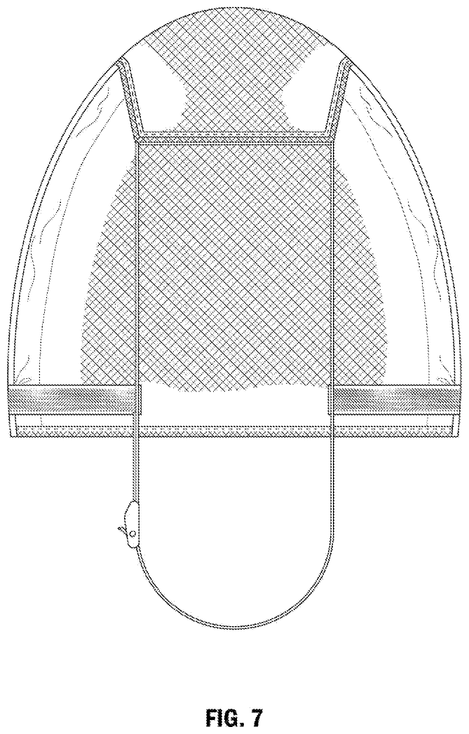

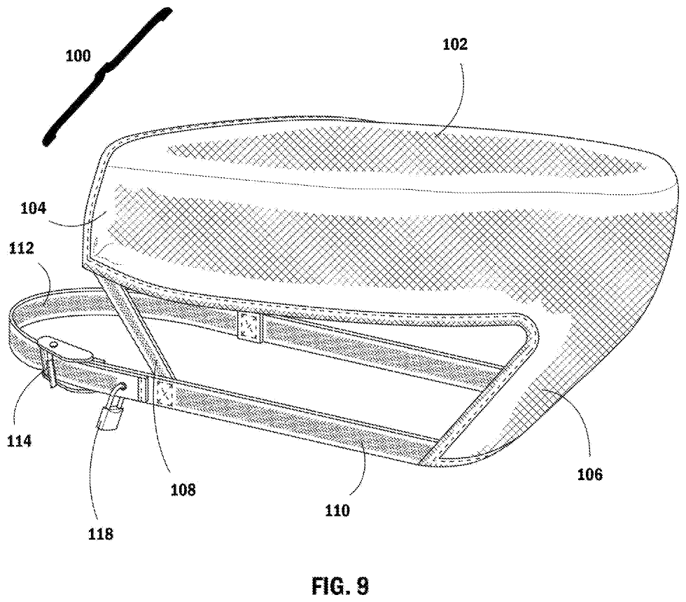

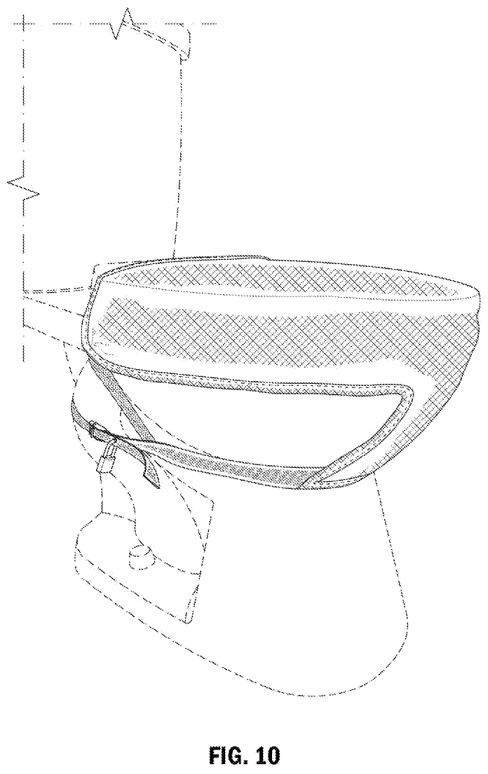

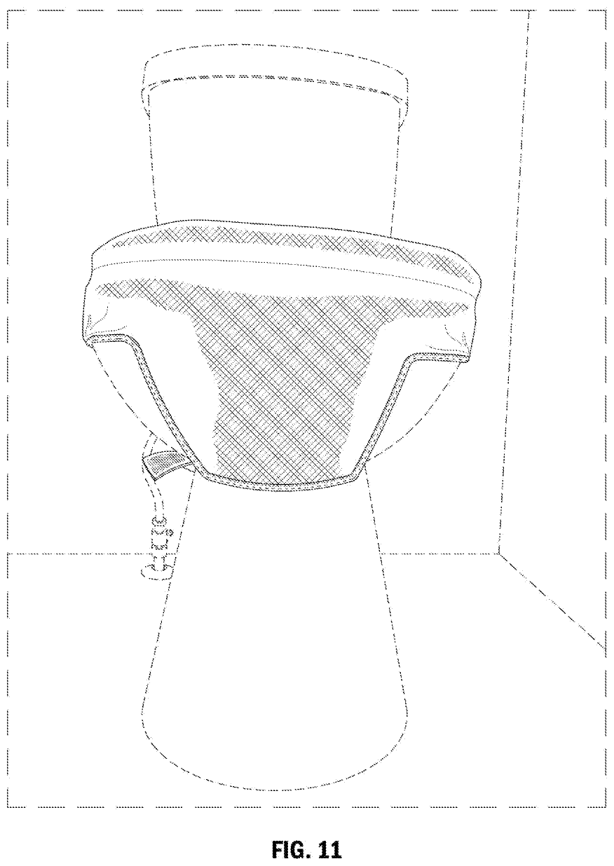

The illustrations of FIGS. 1-14 illustrate a toilet seat locking device, as contemplated by the present disclosure. The toilet seat locking device may comprise, generally, a main body 100, a locking strap 112, and a receiving strap 110. The locking strap 112 and receiving strap 110 may be attached to the main body 100 and may extend around a toilet base so as to engage the main body 100 to the toilet such that it prevents the toilet lid from being opened. In some embodiments the toilet seat locking device may further comprise a plurality of support straps 108, a locking mechanism 114, a plurality of locking holes 116, and a lock 118.

The main body 100 may further comprise a top panel 102, a side panel 104, and a front panel 106. The top panel 102, side panel 104, and front panel 106 may be made from one continuous sheet of material, or may be two or more sheets of material attached to each other as appropriate to the material of construction. By way of example, if the material of construction of a particular embodiment is fabric the various panels may be stitched or glued to one another. If the material of construction is a plastic the various panels may be welded or glued to one another.

In any embodiment the top panel 102 may comprise any appropriately-shaped, substantially horizontal panel suitable for fitting on top of a closed toilet lid. The side panel 104 may comprise any appropriately-shaped, substantially vertical panel suitable for covering the front and both sides of a toilet lid, seat, and bowl. The front panel 106 may comprise any appropriately-shaped, substantially vertical panel suitable for covering the front and both sides of a toilet base.

The top panel 102 may further comprise an upper surface, a lower surface, and a perimeter edge. The side panel 104 may further comprise an outer surface, an inner surface, an upper edge, and a lower edge. The front panel 106 may further comprise an outer surface, an inner surface, an upper edge, and a lower edge. In one embodiment the perimeter edge of the top panel 102 may be fixedly attached to the upper edge of the side panel 104, and the lower edge of the side panel 104 may be fixedly attached to the upper edge of the front panel 106 such that the main body 100 substantially forms a U-shaped cover that may be placed on top of a toilet seat, bowl, and base with the top panel 102 lower surface, side panel 104 inner surface, and front panel 106 inner surface proximal to the toilet.

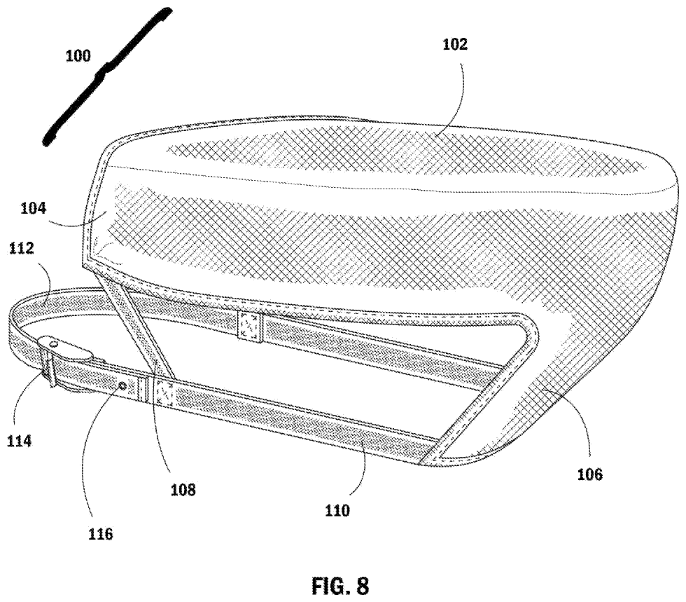

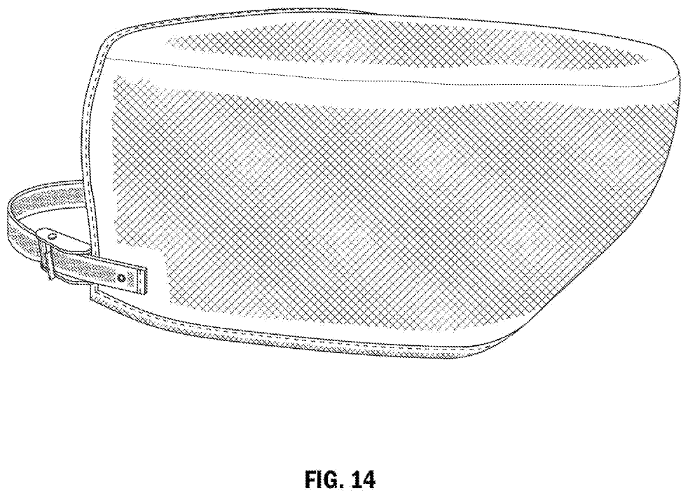

In one embodiment the side panel 104 and the front panel 106 may combine to comprise a complete toilet seat and base cover as shown in FIG. 14. In another embodiment the front panel 106 may only attach to a portion of the side panel 106 to allow for greater flexibility in form or to require less material to construct as shown in FIG. 8. In some embodiments the toilet seat locking device may further comprise a plurality of support straps 108. One of the plurality of support straps 108 may be attached between the main body 100 and the locking strap 112, while another of the plurality of support straps 108 may be attached between the main body 100 and the receiving strap 110.

In any embodiment a first end of the locking strap 112 may be attached to a first side of the main body 100 and a first end of the receiving strap 110 may be attached to a second side of the main body 100. A second end of the receiving strap 110 may further comprise a locking mechanism 114, and a second end of the locking strap 112 may comprise a mechanism complementary to or compatible with the locking mechanism 114. The locking strap 112 and the receiving strap 110 may further comprise a plurality of locking holes 116 that may receive positioning pins or a lock 118, as desired by the selected embodiment.

The locking mechanism 114 may be any appropriate mechanism for reversibly locking two straps together such as, for example, a strap ratchet, a strap tensioner, a strap tightener, a strap hook, or any other appropriate mechanism.

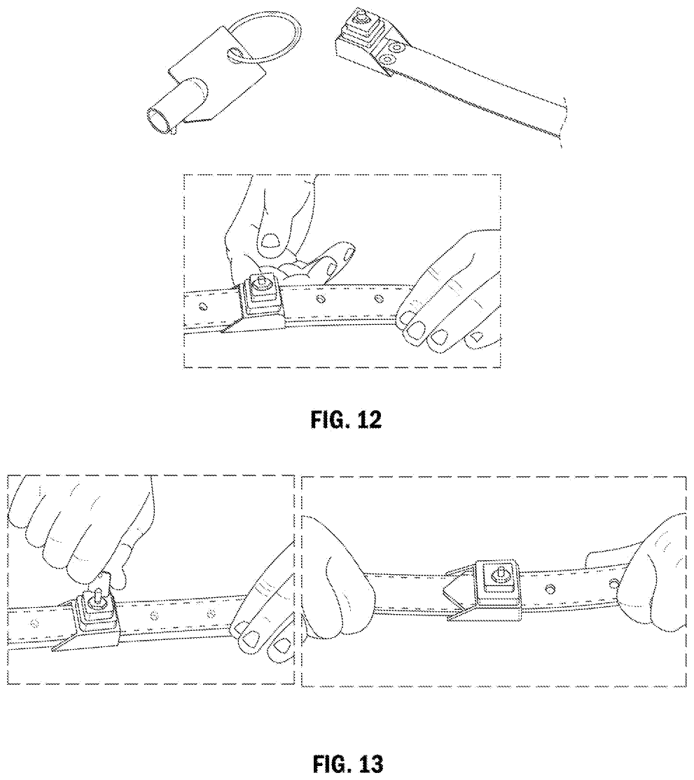

To begin using the device a user may first place the main body 100 on a toilet seat or toilet lid such that the main body 100 covers the desired area. The user may then run the locking strap 112 around the back of the toilet base and insert the second end of the locking strap 112 into the locking mechanism 114 of the receiving strap 110. The user may engage the locking mechanism 114 as appropriate to the particular embodiment. By way of example, the user may ratchet the locking strap 112 to the receiving strap 110, or may hook and loop the first strap to the second, or may insert and clamp the first strap to the second. The user may then align two of the plurality of locking holes 116, one on the locking strap 112 and one on the receiving strap 110, and may install a lock 118 into the holes thus binding the straps together and securing the device to a toilet. In one embodiment the plurality of locking holes 116 may instead be installed over one or more locking pins on the receiving strap 110. In one embodiment the locking mechanism may comprise a keyed pin as seen in FIGS. 12 and 13.

The toilet seat locking device may be substantially constructed of any suitable material or combination of materials, but typically is constructed of a resilient material or combination of materials such that the device is easily manufactured, insulating, and reusable. As an example, and without limiting the scope of the present invention, various exemplary embodiments of the toilet seat locking device may be substantially constructed of one or more materials of plastic, acrylic, polycarbonate, fabric, denim, steel, aluminum, brass, fiberglass, carbon fiber, or combinations thereof. In some embodiments the various components of the device may be coated, lined, or otherwise insulated to prevent contamination of the device.

In one embodiment the toilet seat locking device may comprise a resilient material of construction that either comprises a material having antimicrobial properties or comprises a layering of antimicrobial material or coating. Antimicrobial properties comprise the characteristic of being antibacterial, biocidal, microbicidal, anti-fungal, anti-viral, or other similar characteristics, and the oligodynamic effect, which is possessed by copper, brass, silver, gold, and several other metals and alloys, is one such characteristic. Copper and its alloys, in particular, have exceptional self-sanitizing effects. Silver also has this effect, and is less toxic to users than copper. Some materials, such as silver in its metallic form, may require the presence of moisture to activate the antimicrobial properties.

While the invention has been described in connection with what is presently considered to be the most practical and preferred embodiments, it is to be understood that the invention is not to be limited to the disclosed embodiments, but, on the contrary, is intended to cover various modifications and equivalent arrangements included within the spirit and scope of the appended claims.

I claim:

1. A toilet seat locking device, comprising:
a main body;
a locking strap;
a receiving strap; and
a locking mechanism
wherein said main body comprises a toilet seat cover;
wherein said locking strap is fixedly attached to said main body;
wherein said receiving strap is fixedly attached to said main body;
wherein said locking mechanism is fixedly attached to said receiving strap; and
wherein said locking strap is reversibly attached to said locking mechanism.

2. The toilet seat locking device of claim 1, further comprising:
a plurality of locking holes.

3. The toilet seat locking device of claim 2, further comprising:
a lock.

4. The toilet seat locking device of claim 2, further comprising:
a plurality of support straps.
